(19) United States
(12) Patent Application Publication
(10) Pub. No.: US 2007/0225627 A1
(43) Pub. Date: Sep. 27, 2007

(54) Massaging Method and Apparatus

(76) Inventors: Matthew Cox, GT. Britain (GB); Paul James Cockram, G.T. Britain (GB)

Correspondence Address: Melvin I. Stolz, 51 Cherry Street, Milford, CT, 06460, US

(21) Appl. No.: 11/579,309

(22) PCT Filed: May 18, 2005
(86) PCT No.: PCT/GB05/01914

§ 371 Date: Oct. 31, 2006

(30) Foreign Application Priority Data
May 19, 2004 (GB) 0411128.2

(51) Int. Cl. A61H 15/00

(52) U.S. Cl. 601/113; 601/112

(57) ABSTRACT

A method of massaging a user's back and/or spine includes: —a) providing a frame (10) on which at least two rows of massage elements (27) are mounted, the frame (10) including handles (23, 24) that can be grasped manually, b) mounting the frame (10) on the back of the user so that the massage elements (27) are positioned against the back of the user, c) grasping the handles (23, 24), and d) moving the frame (10) by means of the handles (23, 24) so that the massage elements (27) apply pressure to the user's back and/or spine.

### FIELD OF THE INVENTION

This invention relates to massaging and is concerned with the provision of an improved method of massaging and an improved massaging apparatus.

Many people suffer from pain in the inaccessible areas of the back and spine. All that may be required is a light or firm massage to relieve the pain or stiffness in the affected areas, but these are usually out of reach. A person suffering from pain or stiffness in the back or spine is thus not able independently to apply enough controlled pressure in the affected area to relieve the pain or stiffness.

It is accordingly a specific object of the present invention to provide a method of massaging that can be carried out by a person suffering pain or stiffness in the back or spine independently.

It is also an object of the present invention to provide a massage apparatus for carrying out the method.

Bad posture can have a major adverse effect on a person's general health. For example, it can cause backache, stress on the organs of the body resulting in a reduction of their efficiency, low self-esteem and lack of confidence. When it is noticed that a person's back is becoming hunched over, relief of any muscle tension is required in order to obtain a spinal stretch to correct the person's posture.

When, however, the spine is stiff, it will be noticed that the hip joint will do the flexing as opposed to the lower back and/or spine.

It is accordingly an object of the present invention to provide a method of massaging that enables the lower back and/or spine to be stretched without the person's hip moving, thereby relieving stiffness and improving the person's posture.

### SUMMARY OF THE INVENTION

According to a first aspect of the present invention there is provided a method of massaging a user's back and/or spine that includes:—

a) providing a frame on which at least two rows of massage elements are mounted, the frame including handles that can be grasped manually,

b) mounting the frame on the back of the user so that the massage elements are positioned against the back of the user,

c) grasping the handles, and

d) moving the frame by means of the handles so that the massage elements apply pressure to the user's back and/or spine.

According to a second aspect of the present invention there is provided a massage apparatus for carrying out the above method, the apparatus including:—

a) a frame on which at least two rows of massage elements are mounted,

b) handles that can be grasped manually, and

c) means for mounting the frame on the back of the user so that the massage elements are positioned against the back of the user, so that, by grasping the handles, the user can move the frame so that the massage elements apply pressure to the user's back and/or spine.

The means for mounting the frame on the back of the user preferably includes an elasticated element and webbing or straps that pass over the user's shoulders.

There are preferably either two or three rows of massage elements, which may be of generally spherical configuration, and a vibrating unit may be provided for effecting vibration of the massage elements.

### BRIEF DESCRIPTION OF THE DRAWINGS

FIG. 1 is a perspective view of the massage apparatus without its mounting means,

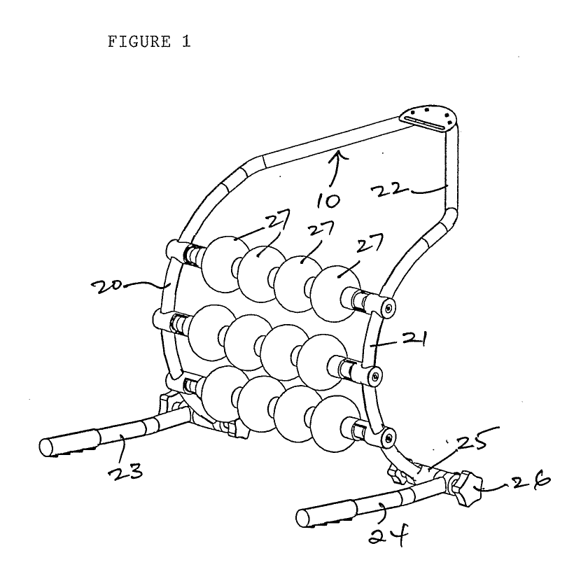

FIG. 2 is a side view of the apparatus of FIG. 1,

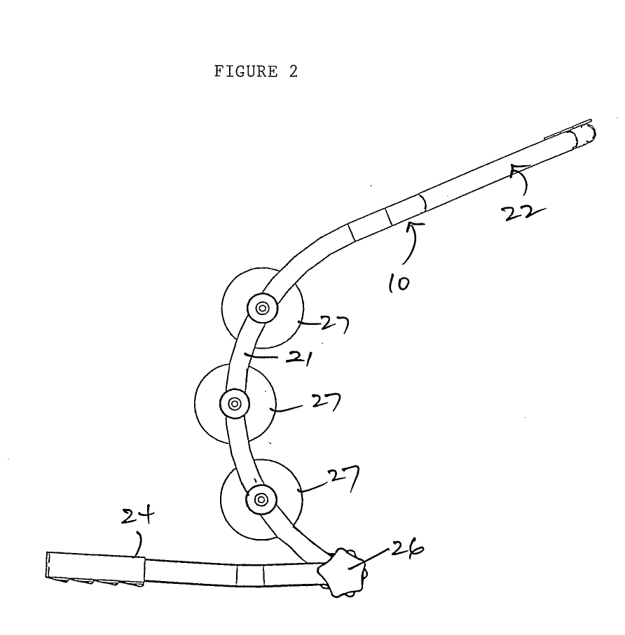

FIG. 3 is a plan view of the apparatus of FIG. 1,

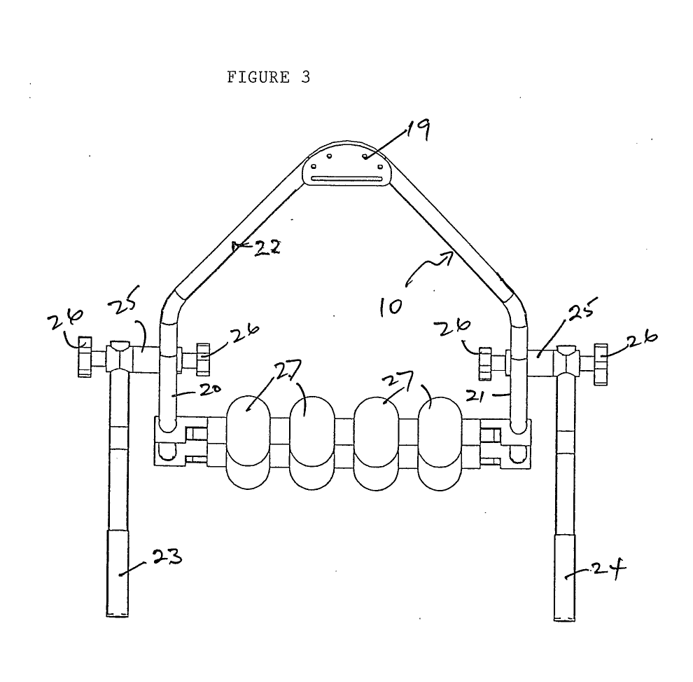

FIG. 4 is a perspective view of the massage apparatus and its mounting means illustrating the positions of the apparatus and mounting means when mounted on the body of a user, and

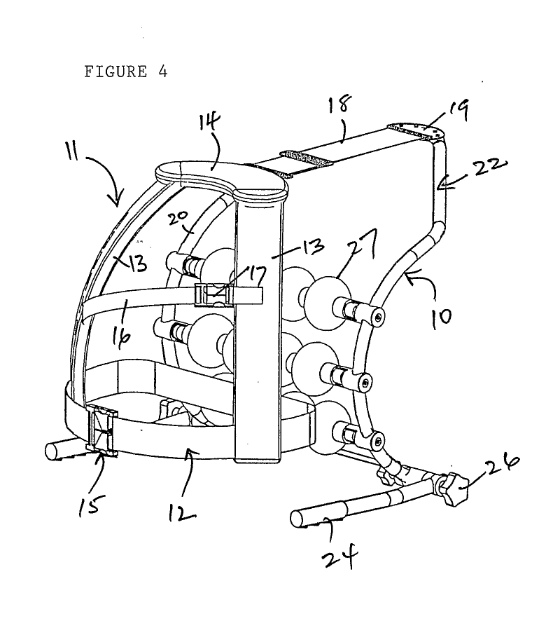

FIG. 5 is a side view of the arrangement shown in FIG. 4.

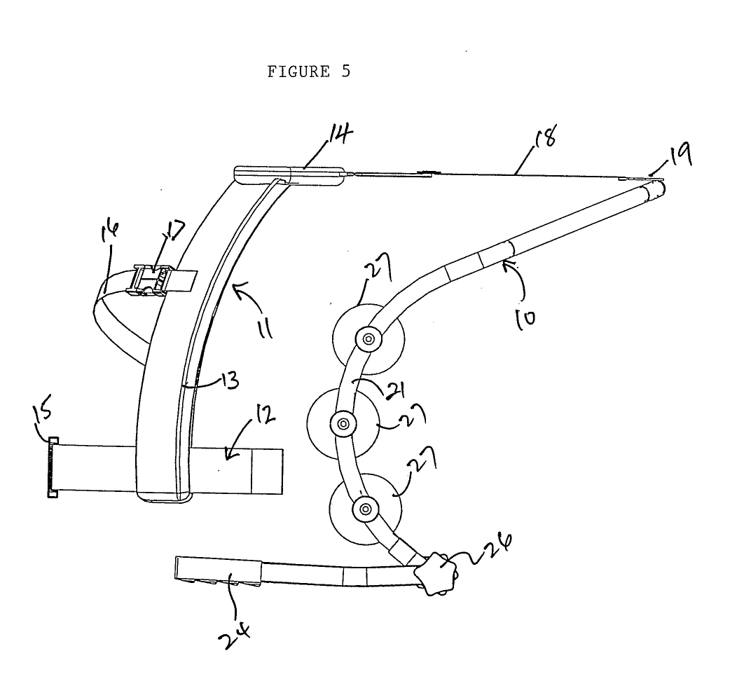

### DESCRIPTION OF THE PREFERRED EMBODIMENT

In order to carry out a massaging operation, a user attaches a frame 10 to his or her body by a mounting means 11 that includes a belt 12 that passes around the waist of the user and is connected by straps 13 to a shoulder pad 14 that rests on the shoulders of the user. The belt 12 is secured at the front by means of a buckle fastener 15 that is adjustable to suit the size of the user. The straps 13 can also be interconnected by a further strap 16 that includes a buckle fastener 17 that is adjustable to suit the size of the user.

The shoulder pad is attached to the frame 10 by means of an elasticated strip 18 that is adjustable in length and is fixed releasably to a holder 19 forming part of the frame 10. As shown in the drawings, the frame 10 includes a pair of parallel side members 20 and 21 interconnected by a top member 22 (on which the holder 19 is mounted) and a pair of handles 23 and 24. The handles 23 and 24 are connected to the ends of the side members 20 and 21 by connections that include connectors 25 that are designed to enable the inclinations of the handles 23 and 24 relative to the side members 20 and 21 to be adjusted as desired. The handles 23 and 24 are fixed at the desired inclinations by tightening knobs 26. The side members 20 and 21 are of curvate form in side view, as shown in the drawings, and rows of massage elements 27 extend between the side members 20 and 21.

As shown, there are three rows of massage elements 27, but in other embodiments of the invention, two rows of massage elements may be employed. The massage elements 27 may be of spherical configuration, as shown, but may be in the form of spheres having an array of part-spherical protuberances.

The frame 10 acts as a leverage system and the use of an elasticated strip 18 connected to the frame 10 facilitates the use of tension within the design. The user grasps the handles 23 and 24 and moves the handles forwardly and rearwardly so that the frame pivots about the point or axis of contact of the massage elements 27 with the back of the user. The user stimulates selected areas of his or her back and/or spine with the massage elements 27 by grasping the handles 23 and 24 and moving the frame 10 as required, utilising the specific design angles of the frame 10. It is possible to so move the handles 23 and 24 as to vary the inclination of the frame 10 to increase or decrease the tension in the elasticated element 18 and thereby the spinal stretch. The design is also such as to enable the user to apply a controlled pressure, as necessary, by varying the pressure by which the user urges the frame 10 towards his or her back.

The means for mounting the frame on the back of the user may comprises a wishbone-shaped strapping system which includes a halter-style fitting that sits around the neck of the user and curves over the front shoulders of the user and returns under the arms, where it crosses at a centre point of the back of the user at waist level. This cross-over may be guided by means of a banded loop. From the cross-over position, the straps can be pulled simultaneously from the left sand right sides, so tightening the straps comfortable over the shoulders, under the arms and across the back of the user. The straps continue around the waist of the user and are fastened by a clip at the front. A slide permitting further adjustment of the strap length is disposed adjacent the front clip.

The strapping is attached to the frame 10 by the use of a wide band of elastic that is connected to the centre neck point of the halter.

The invention thus permits the carrying out of an active massage treatment without the need for a personal assistant. The user is thus in constant control of the applied pressure and tension and can ensure that the degree of applied stretch and pressure are continuously maintained at a level compatible with the user's comfort and fitness.

The massage elements 27 may incorporate vibrators (not shown) and the use of vibrators within the massage area will further increase the effectiveness of the treatment and will enhance the user's feeling of well-being.

The use of the apparatus thus provides a stimulating active massage and facilitates the application of different degrees of massage pressure. Use of the apparatus increases spinal flex and the apparatus can also be used to aid the dispersion of inflammatory fluids. Passive and active stretches are promoted and normally inaccessible areas can be massaged.

The frame 10 can also be detached from its mounting means and placed on the floor adjacent a chair on which the user sits, placing his or her legs in contact with the massage elements 27 so that, on moving the legs relative to the massage elements, a massaging action is obtained.

1. A method of massaging a user's back and/or spine that includes:—
a) providing a frame on which at least one row of massage elements are mounted, the frame including handles that can be grasped manually,
b) mounting the frame on the back of the user so that the massage elements are positioned against the back of the user,
c) grasping the handles, and
d) moving the frame by means of the handles so that the massage elements apply pressure to the user's back and/or spin.

2. A method as claimed in claim 1, in which the frame is mounted on the back of the user using straps having buckle fasteners.

3. A method as claimed in claim 1, in which the frame is mounted on the back of the user using an elasticated element.

4. A method as claimed in claim 3, in which the frame is tilted against the reaction provided by the elasticated element

5. A massage apparatus for carrying out the method of claim 1, the apparatus including:—
a) a frame on which at least one row of massage elements are mounted,
b) handles that can be grasped manually, and
c) means for mounting the frame on the back of the user so that the massage elements are positioned against the back of the user, so that, by grasping the handles, the user can move the frame so that the massage elements apply pressure to the user's back and/or spine.

6. Apparatus as claimed in claim 5, in which the means for mounting the frame on the back of the user includes an elasticated element.

7. Apparatus as claimed in claim 6, in which the means for mounting the frame on the back of the user includes straps.

8. Apparatus as claimed in claim 5, in which there are three rows of massage elements.

9. Apparatus as claimed in claim 8, in which the massage elements are of generally spherical configuration.

10. Apparatus as claimed in claim 5, in which the frame includes side members and in which the handles are connected to the side members by means of connectors that permit adjustment of the inclinations of the handles relative to the side members.
